(19) United States
(12) Patent Application Publication
(10) Pub. No.: US 2002/0083961 A1
(43) Pub. Date: Jul. 4, 2002

(54) Method and apparatus for cleaning semiconductor wafer

(76) Inventor: Toshihito Tsuga, Tsuchiura-shi (JP)

Correspondence Address: TEXAS INSTRUMENTS INCORPORATED, P O BOX 655474, M/S 3999, DALLAS, TX, 75265

(21) Appl. No.: 09/969,467

(22) Filed: Oct. 2, 2001

(30) Foreign Application Priority Data
Oct. 4, 2000 (JP) 2000-304,638

(51) Int. Cl. B08B 7/00

(52) U.S. Cl. 134/1.3; 134/19; 134/31; 134/33; 134/105; 134/902; 134/153

(57) ABSTRACT

To clean a semiconductor wafer without using a harmful liquid chemical solution such as piranha and organic solvent

A vapor is generated by heating ultrapure water and it is blown to the surface of a semiconductor wafer at a temperature of 85° C. or higher. Even when the above-mentioned vapor is blown at a low pressure of 4.5 kg/cm² or less, photoresist or an organic substance can be removed from the semiconductor wafer surface.

### FIELD OF THE INVENTION

The present invention pertains to a method and apparatus for cleaning a semiconductor wafer and that removes a photoresist or an organic substance from the surface of the semiconductor wafer.

### BACKGROUND OF THE INVENTION

In the manufacturing processes for a semiconductor device, a fine pattern based on a circuit design is formed on a semiconductor wafer surface by fine working techniques of lithography and etching. In the lithography process of the semiconductor wafer surface, a photoresist (photosensitive organic high-molecular substance) solution is spread on the semiconductor wafer surface provided with a polycrystalline Si thin film, for instance, by a spin-coating method, and the solvent is removed by baking. Next, through a photomask having a prescribed design pattern, the photoresist is exposed to ultraviolet rays, and the photoresist part that is soluble in a developing solution is removed, thereby obtaining a desired pattern. In a post-etching process, the polycrystalline Si is etched using the pattern as a mask material. The photoresist on the semiconductor wafer surface is removed in a cleaning process using a liquid chemical solution after each etching process.

The conventional cleaning method for removing the photoresist is carried out with a mixed solution (H₂SO₄/H₂O₂) of sulfuric acid and hydrogen peroxide generally called a piranha heated to 130° C. or higher after a dry-ashing process using O₂ plasma, etc.

However, in the method for removing the photoresist by using piranha, the following problems occur.

(1) Since cleaning with piranha is carried out at high temperature exceeding 130° C., it is necessary to constitute an apparatus using a special chemical-resistant and heat-resistant material for housing, circulating, filtering, and discharging the liquid chemical solution, and the cleaning apparatus is expensive.

(2) Since hydrogen peroxide is used as an oxidant, water (H₂O) is generated as a by-product when reacting with the photoresist, and the water lowers the concentration of the liquid chemical solution in the cleaning tank, so that the removal performance for the photoresist is lowered.

(3) Since the solution is usually a high-concentration liquid chemical solution in which about 98% sulfuric acid and about 30% hydrogen peroxide are mixed at a ratio of 3:1-4:1, it is a harmful material, and its influence on the environment is large. Also, in cleaning, a large amount of said solution is consumed, and the cost is very high for waste solution treatment.

(4) Since cleaning is usually carried out by so-called batch type cleaning (cleaning in the tank), there is a very high possibility that the photoresist and other impurities removed from the semiconductor wafer surface will accumulate in the tank and be reattached as particles to the semiconductor wafer. In order to alleviate this problem, the liquid chemical solution is periodically replaced; however cooling is required during the replacement, so that much work time and labor are required.

Also, in cleaning in a metal wiring process using aluminum and copper, an organic solvent is used instead of piranha. Furthermore, cleaning has recently been applied using sulfuric acid containing ozone (O₃/H₂SO₄) in which ozone gas is added to sulfuric acid, water (O₃/DIW) containing ozone in which ozone gas is added to ultrapure water, etc., as substitutes for the above-mentioned piranha.

The above-mentioned organic solvent is a very harmful liquid chemical solution containing dimethylformamide (DMF), etc., and the reduction of its use is desired. At the same time, similarly to piranha, its consumption cost and waste solution treatment cost are large.

In cleaning using the above-mentioned sulfuric acid (O₃/H₂SO₄) containing ozone, in order to generate the solution, ozone gas is jetted into high-concentration (100-150° C.) sulfuric acid in the tank; since the size of the bubbles of ozone in the process is nonuniform, it is very difficult to uniformly distribute the ozone in the solution, so that scatter in the cleaning quality results. Also, in this case, since a high-temperature/high-concentration liquid chemical solution is used, there are problems similar to the above-mentioned problems (1), (3), and (4) when piranha is used.

On the other hand, although the cleaning using the water containing ozone (O₃/DIW) is advantageous in terms of cost and environmental pollution, compared with the case where any of above-mentioned solutions is used, its cleaning ability is low, and it is necessary to generate the water containing ozone at a high ozone concentration (60 ppm or more) to remove the photoresist from the semiconductor wafer surface. For this reason, Teflon such as PFA (ethylene tetrafluoride/perfluoroalkylvinyl ether copolymer resin) and PTFE (ethylene tetrafluoride resin) is damaged when it is in use over a long time, resulting in pollution. Also, in order to obtain the water containing ozone with 60 ppm or more ozone, deaerated ultrapure water must be cooled down to about 5° C. When the water containing ozone is applied to batch type cleaning, precise control of its temperature and concentration is very difficult.

Therefore, the objective of the present invention is to provide a method and apparatus for cleaning a semiconductor wafer that solves the problems in cleaning a photoresist using the above-mentioned conventional solutions.

Also, the objective of the present invention is to provide a method and apparatus for cleaning a semiconductor wafer that effectively removes organic substances attached to the surface of a semiconductor wafer.

### SUMMARY OF INVENTION

This inventor discovered a revolutionary cleaning method that removes photoresist and organic substances by vaporizing ultrapure water through heating and by blowing it onto the surface of a semiconductor wafer. In other words, the present invention is a method for cleaning a semiconductor wafer that removes a photoresist or an organic substance from the surface of a semiconductor wafer, and it consists of a process that generates vapor by heating ultrapure water and a process that removes the photoresist or organic substance from the above-mentioned semiconductor wafer surface by blowing the above-mentioned vapor onto the above-mentioned semiconductor wafer surface.

The mechanism for removing the photoresist or organic substance by the above-mentioned method of the present invention is not clear at present. However, it is believed that a certain energy is given to ultrapure water by vaporizing the ultrapure water, the aggregates (H₂O)ₙ of H₂O having the very rare characteristic of a dipole moment are changed, and the intrinsic viscosity, permeability, number of radicals (H*, OH*), etc., are changed, so that a solution (vapor) that can remove the photoresist or organic substance is obtained.

Here, according to experiments, in the process that blows the above-mentioned vapor onto the above-mentioned semiconductor wafer surface, the temperature of the vapor being blown to the above-mentioned semiconductor wafer surface is preferably 85° C. or higher.

The pressure of the vapor being blown to the above-mentioned semiconductor wafer surface may be 5 kg/cm² or less, preferably 1 kg/cm² or more.

The blowing time period of the vapor to the above-mentioned semiconductor wafer surface can be controlled to 30 sec or less.

The present invention further includes a process that rotates the above-mentioned semiconductor wafer, and a process that blows the above-mentioned vapor onto the above-mentioned semiconductor wafer surface blows the above-mentioned vapor onto the above-mentioned semiconductor wafer surface being rotated.

The present invention can further include a process that increases the number of hydroxyl radicals in the vapor being blown onto the above-mentioned semiconductor wafer surface by irradiating ultraviolet rays into the above-mentioned vapor.

In a detailed method of the present invention, the process that blows the above-mentioned vapor onto the above-mentioned semiconductor wafer surface can include a process that jets the above-mentioned vapor from a nozzle being moved relative to the above-mentioned semiconductor wafer surface.

The present invention also pertains to an apparatus for cleaning a semiconductor wafer that removes a photoresist or an organic substance from the surface of a semiconductor wafer. The apparatus of the present invention is equipped with a vapor generation means that generates vapor by heating ultrapure water and a vapor jet means that removes the photoresist or organic substance from the above-mentioned semiconductor wafer surface by blowing the vapor generated by the above-mentioned vapor generation means to the above-mentioned semiconductor wafer surface.

### BRIEF DESCRIPTION OF THE DRAWINGS

FIG. 1 is an outlined constitutional diagram showing an embodiment of a cleaning apparatus constituted to apply the cleaning method of the present invention.

FIG. 2 is a table showing measurement results of the performance in removal of a photoresist by the present invention.

FIG. 3 is a table showing measurement results of the performance in removal of an organic substance by the present invention.

### REFERENCE NUMERALS AND SYMBOLS AS SHOWN IN THE DRAWINGS

In the figures, 100 represents a cleaning apparatus, 102 a water storage tank, 104 a heat source, 106 a vapor feed pipe, 108 a nozzle, 110 a turntable.

### DESCRIPTION OF EMBODIMENTS

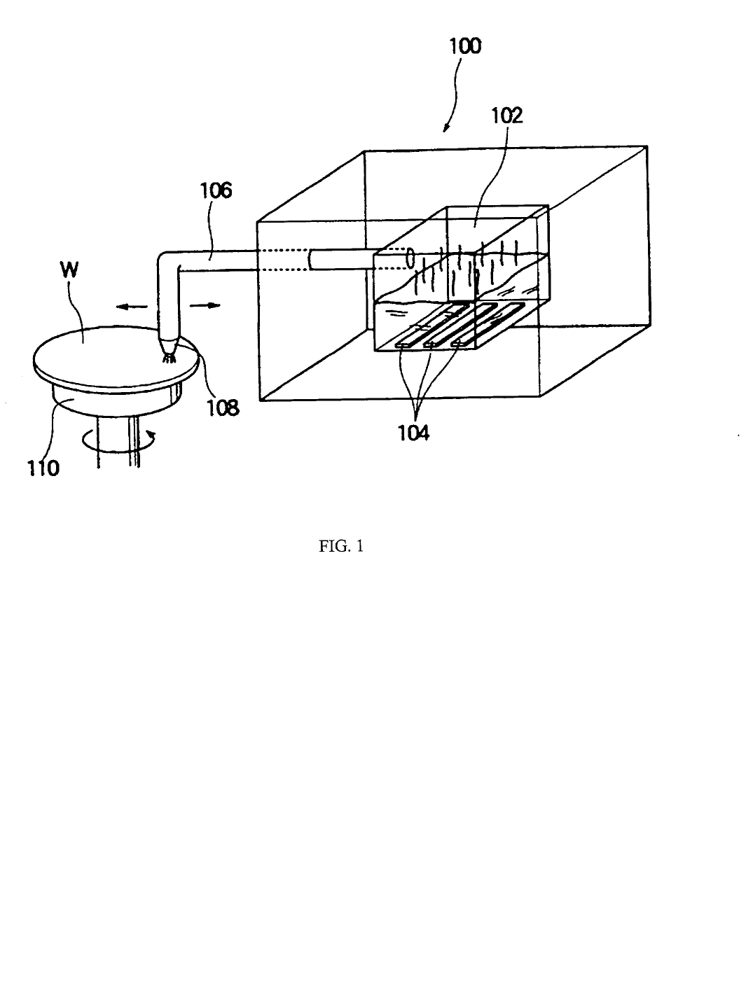

Next, an embodiment of the present invention will be explained using a figure. FIG. 1 is an outlined constitutional diagram showing an embodiment of the cleaning apparatus constituted to apply the cleaning method of the present invention. In the following explanation, the present invention will be explained for a case where a photoresist used to process an oxide film (SiO₂) on a silicon wafer is removed from the wafer surface.

A cleaning apparatus 100 of the present invention vaporizes ultrapure water (DIW) and jets it onto a silicon wafer W, and a water storage tank 102 is provided in the apparatus. The water storage tank 102 has a capacity for storing a fixed amount of ultrapure water, and the ultrapure water in the water storage tank 102 is boiled by an electrothermal wire heater and other heat sources 104 disposed at the bottom, so that it is vaporized. As seen from experimental data that will be mentioned later, the temperature of the vapor supplied to the silicon wafer W is important in the application of the present invention. From the experimental data, the temperature is preferably 85° C. or higher, more preferably 90° C. or higher.

A vapor feed pipe 106 extends from the upper part of the water storage tank 102, and the vapor generated in the water storage tank 102 is passed through the pipe and exposed at a prescribed pressure into the air from a nozzle 108 of the tip of the pipe and supplied to the surface of the silicon wafer W. The nozzle 108 is disposed so that it may face the surface of the silicon wafer W. In applying the present invention, the pressure of the vapor supplied to the surface of the silicon wafer W is not necessarily required to be at a high level. However, it is necessary for the vapor to have a fixed pressure and to be exposed to the silicon wafer W. According to experimental results, the pressure of the vapor exposed to the silicon wafer W may be 5 kg/cm² or less and may be 1.1 kg/cm² or more in a preferred embodiment. The diameter and the installation height of the nozzle and if necessary, the setup of a pressure regulating valve are adjusted so that a vapor with the above-mentioned appropriate pressure may be applied to the surface of the silicon wafer W.

In a preferred embodiment, the nozzle 108 is constituted in such a manner that it can be moved in the radial direction of the silicon wafer W. The silicon wafer W is fixed on a turntable 110 by wafer chucks or wafer holding pins (the pins are made of a fluororesin, and the number of pins is 3-8) (the turntable 110 is installed in a housing subjected to dust removal treatment, which housing is not shown in the figure). When the vapor is exposed to the surface of the silicon wafer W by the cleaning apparatus 100, the turntable 110 is driven, and the silicon wafer W is rotated. With the rotation of the turntable 110 and the movement in the radial direction of the above-mentioned nozzle 108, the above-mentioned vapor can be jetted over the entire area of the silicon wafer W. In applying the present invention, the rotation speed of the turntable 110 may be about 100-2000 rpm. Needless to say, the above-mentioned nozzle may also be constituted by forming several vapor discharge ports at a prescribed interval along the lower surface of the feed pipe extending in the radial direction of the silicon wafer W. Also, the nozzle 108 does not have to face the silicon wafer W as long as it is guaranteed that the vapor is applied at a fixed pressure to the surface of the silicon wafer W. As another constitution, several sheets of silicon wafers W are coaxially held at a prescribed interval on a single cylinder, the nozzle is disposed toward the silicon wafers at the cylinder side, and the vapor of ultrapure water is jetted. Persons skilled in the art will understand that many various well-known techniques can be utilized to jet vapor at a prescribed pressure to the entire surface of silicon wafers W.

The silicon wafer W is cleaned in the following sequence by using the cleaning apparatus 100 with the above-mentioned constitution. The ultrapure water at room temperature (about 25° C.) is supplied into the water storage tank 102 and boiled by heating the heat source 104, so that vapor is generated. With the adjustment of the output of the heat source 104 and the pressure regulating valve of the water storage tank 102, the vapor generated is raised to a prescribed temperature.

The silicon wafer W is transferred into the housing subjected to the dust removal treatment, which is not shown in the figure, by a robot hand and another transfer means and fixed onto the turntable 110 via the wafer chucks. The nozzle 108 is installed above the silicon wafer W. and while the turntable 110 is driven at 100-2,000 rpm and the nozzle 108 is driven at about 0.5-2.0 cm/sec, the nozzle 108 is opened. The above-mentioned vapor generated at a prescribed temperature is jetted onto the silicon wafer W. Cleaning is applied with the above-mentioned vaporized ultrapure water for about 3-30 sec, and the treatment is finished. Since only ultrapure water is used as the solution in the above-mentioned cleaning, only photoresist is included in the waste solution and is removed by a filter and the filtrate is discarded as is as water or it can be reutilized.

Embodiment 1

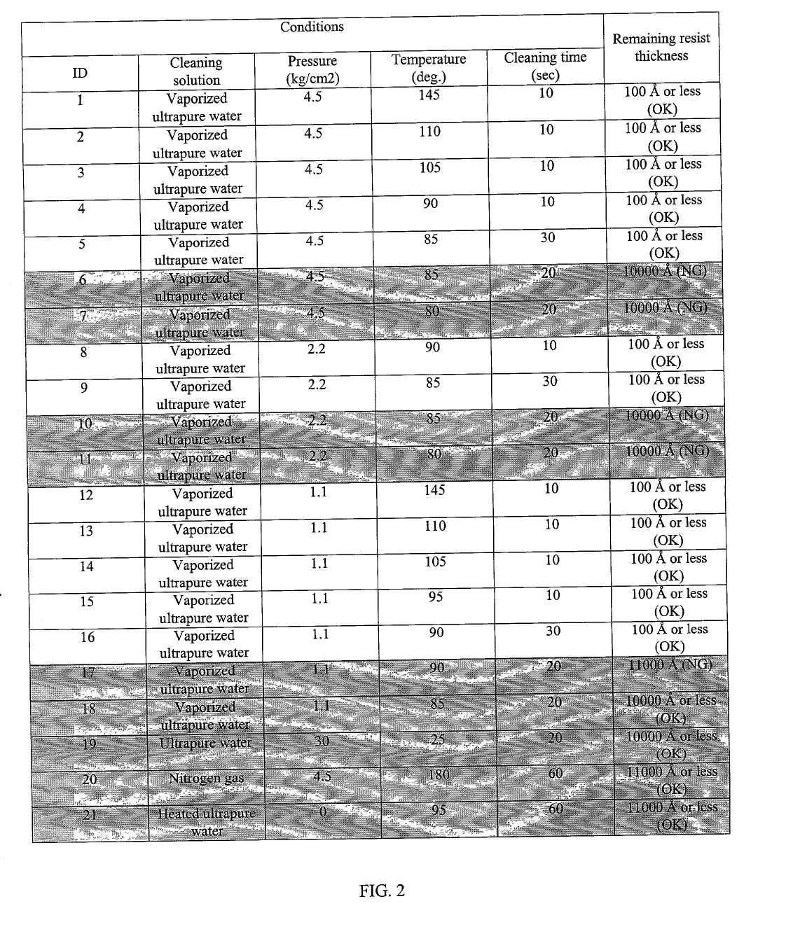

This inventor conducted experiments under several conditions to verify the effects of the cleaning method of the present invention. In the experiments, a representative photoresist mainly composed of 2-heptanone and novolak resin was spread at a thickness of 11,000 Å on a 6 inch silicon wafer, baked at about 110° C. and etched by a plasma, so that a sample was obtained. The pressure, temperature, and cleaning time of the vapor were varied, and the vaporized ultrapure water was jetted onto the silicon wafer surface. Then, the thickness of the remaining film of the photoresist was measured by a film thickness measurer. In jetting the vaporized ultrapure water in the present invention to the silicon wafer surface, the pressure was varied in a range of 1.1-4.5 kg/cm², the temperature was varied in a range of 80-145° C., and the cleaning time was varied in a range of 10-30 sec. Also, for comparison, cleaning was applied using non-vaporized ultrapure water at normal temperature and heated to 95° C. and also using nitrogen (N₂) gas as a solution, and the results were measured. A nozzle with a diameter of 3 mm was used to jet vapor and it was installed 3 mm above the surface of the silicon wafer. Measurement results are shown in FIG. 2.

According to the results, in the case where cleaning was applied using non-vaporized ultrapure water at normal temperature and heated to 95° C. and also using nitrogen (N₂) gas as a solution, the photoresist could not be effectively removed, even by raising the pressure and the cleaning time. In the case where the vaporized ultrapure water of the present invention was used, the photoresist was effectively removed under prescribed conditions. The remaining resist thickness of 100 Å or less in the table shows that the film thickness of the photoresist after cleaning was at the measurement limit or less of the film thickness measurer used in the measurement. From the results, it was shown that if the temperature of the vaporized ultrapure water was 85° C. or higher, the photoresist was removed by cleaning in 30 sec or less, even if the jet pressure was as low as 2.2 kg/cm². Also, it was shown that if the temperature was 90° C. or higher, the photoresist was effectively removed by cleaning at a pressure of 2.2 kg/cm² for 10 sec or less and a pressure of 1.1 kg/cm² for 30 sec or less. Furthermore, in experiments, the photoresist was removed from the wafer surface in a cleaning time of 3 sec or less under the conditions of a temperature of 145° C. and a pressure of 4.5 kg/cm².

Embodiment 2

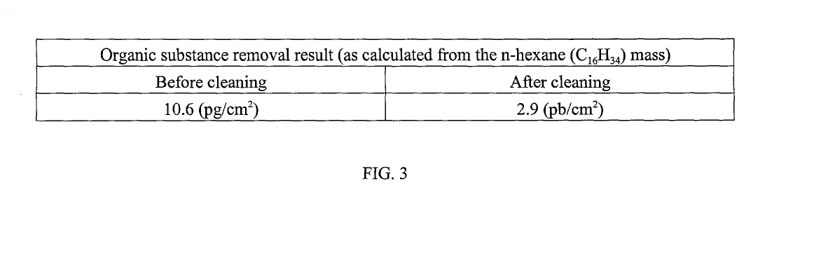

This inventor removed organic contaminant attached onto a silicon wafer under conditions similar to the above-mentioned conditions. In this application example, the pressure of the vapor was set at 4.5 kg/cm², the temperature was set at 90° C., and the cleaning time was set at 60 sec. The concentration of the contaminant attached to the silicon wafer was compared before and after cleaning. The results are shown in FIG. 3. As seen from the figure, the [amount of] organic contaminant attached to the surface before cleaning was markedly lowered after cleaning. The data of FIG. 3 were shown through a mass conversion by n-hexane (C₁₆H₃₄) and were obtained by a thermal desorption spectroscopy method.

As discussed above, it was shown that when a very simple and unexpected method, which only jetted ultrapure water onto the vaporized wafer surface, was applied to clean a photoresist and organic substance on a semiconductor wafer, the [contaminants] could be effectively removed.

Herein, embodiments of the present invention have been explained using figures. However, it is apparent that the present invention is not limited to the above-mentioned embodiments but can be modified and improved based on the scope of the claims. Ultraviolet rays with a prescribed wavelength (for example, 242 nm or less, preferably 172 nm or less) are irradiated into a vapor composed of ultrapure water, and the generation of hydroxyl radicals in the vapor is accelerated thereby, so that the oxidation-reduction potential is raised, thereby improving the cleaning ability. The ultraviolet rays may be directly irradiated into the vapor and also irradiated onto the surface of the semiconductor wafer. Also, light other than ultraviolet rays may be irradiated. Furthermore, in order to generate a larger amount of said hydroxyl radicals, O₂ is preferably included in the ultrapure water (a method via a dissolving module or a method for bubbling O₂ gas can be used). Also, the pressure of the vapor can be raised to about 30 kg/cm² without damage to patterns formed on the semiconductor wafer. In this case, the cleaning time is extremely shortened.

As mentioned above, in the present invention, since only vaporized ultrapure water is used as the cleaning solution, the following benefits can be obtained.

(1) In the cleaning method of the present invention, since harmful liquid chemicals such as piranha and organic solvents are not used, the environmental characteristics are excellent, and the conventional liquid chemical solution consumption cost and waste solution treatment cost can be largely reduced.

(2) Since the cleaning processes and apparatus constitution can be greatly simplified, the number of work processes and the work time can be largely reduced, and the facility cost and the area occupied by the apparatus can be extremely reduced.

(3) According to the present invention, since the photoresist and organic substances can be removed at very high efficiency, performance improvement of devices using the wafers is expected.

1. A method for cleaning a semiconductor wafer, characterized by the fact that in a method for cleaning a semiconductor wafer that removes a photoresist or an organic substance from the surface of a semiconductor wafer, it includes a process that generates vapor by heating ultrapure water and a process that removes the photoresist or organic substance from the above-mentioned semiconductor wafer surface by blowing the above-mentioned vapor onto the above-mentioned semiconductor wafer surface.

2. The method for cleaning a semiconductor wafer of claim 1, characterized by the fact that in the process that blows the above-mentioned vapor onto the above-mentioned semiconductor wafer surface, the temperature of the vapor being blown onto the above-mentioned semiconductor wafer surface is 85° C. or higher.

3. The method for cleaning a semiconductor wafer of claim 1 or 2, characterized by the fact that in the process that blows the above-mentioned vapor onto the above-mentioned semiconductor wafer surface, the pressure of the vapor being blown onto the above-mentioned semiconductor wafer surface is 5 kg/cm² or less.

4. The method for cleaning a semiconductor wafer of claim 3, characterized by the fact that in the process that blows the above-mentioned vapor onto the above-mentioned semiconductor wafer surface, the pressure of the vapor being blown onto the above-mentioned semiconductor wafer surface is 1 kg/cm² or more.

5. The method for cleaning a semiconductor wafer of any of claims 1-4, characterized by the fact that in the process that blows the above-mentioned vapor onto the above-mentioned semiconductor wafer surface, the blowing time period of the vapor onto the above-mentioned semiconductor wafer surface is 30 sec or less.

6. The method for cleaning a semiconductor wafer of any of claims 1-5, characterized by the fact that it further includes a process that rotates the above-mentioned semiconductor wafer; and the process that blows the above-mentioned vapor onto the above-mentioned semiconductor wafer surface blows the above-mentioned vapor onto the above-mentioned semiconductor wafer surface being rotated.

7. The method for cleaning a semiconductor wafer of any of claims 1-6, characterized by the fact that it further includes a process that increases the number of hydroxyl radicals in the vapor being blown onto the above-mentioned semiconductor wafer surface by irradiating ultraviolet rays into the above-mentioned vapor.

8. The method for cleaning a semiconductor wafer of any of claims 1-7, characterized by the fact that the process that blows the above-mentioned vapor onto the above-mentioned semiconductor wafer surface includes a process that jets the above-mentioned vapor from a nozzle being moved relative to the above-mentioned semiconductor wafer surface.

9. An apparatus for cleaning a semiconductor wafer, characterized by the fact that in a method for cleaning a semiconductor wafer that removes a photoresist or an organic substance from the surface of a semiconductor wafer, it includes a vapor generation means that generates vapor by heating ultrapure water and a vapor jet means that removes the photoresist or organic substance from the above-mentioned semiconductor wafer surface by blowing the vapor generated by the above-mentioned vapor generation means onto the above-mentioned semiconductor wafer surface.
